(19) United States
(12) Patent Application Publication
(10) Pub. No.: US 2024/0015189 A1
(43) Pub. Date: Jan. 11, 2024

(54) A SERIAL VIDEO CONFERENCING SYSTEM THAT AUTOMATICALLY AND SEAMLESSLY TRANSITIONS USERS FROM ONE MEETING TO ANOTHER

(71) Applicant: PHYSICIAN DIRECT, Royersford, PA (US)

(72) Inventors: Michael WOODHULL, Sioux Falls, SD (US); Stan HERRIN, Galena, MD (US)

(21) Appl. No.: 18/252,310

(22) PCT Filed: Nov. 22, 2021
(86) PCT No.: PCT/US2021/060399

§ 371 Date: May 9, 2023

Related U.S. Application Data
(60) Provisional application No. 63/116,793, filed on Nov. 20, 2020.

(51) Int. Cl. H04L 65/1069; H04L 12/18

(52) U.S. Cl. CPC H04L 65/1069; H04L 12/1818

(57) ABSTRACT

A computer-implemented method for providing seamless video conferencing system includes receiving a plurality of participants for a video conferencing session. A match between the plurality of participants for the video conferencing session is identified based on participant criteria. One or more meetings is scheduled sequentially between the matched participants. The scheduled one or more meetings sequentially is hosted and provided without receiving from the plurality of participants, session login data associated with the video conferencing session.

This application claims the benefit of U.S. Provisional Patent Application Ser. No. 63/116,793, filed Nov. 20, 2020, which is hereby incorporated by reference in its entirety.

### TECHNICAL FIELD

The present application generally relates to video conferencing, and more particularly, to provide a serial video conferencing system that automatically and seamlessly transitions users from one meeting to another and devices thereof.

### BACKGROUND

A hundred or more commercially available video meeting platforms currently exist. These existing video meeting platforms have several disadvantages which will be further described as follows: first, existing technologies that are routine, conventional, and well-understood, involves two or more people meeting each other by phone, in-person, or through online platforms and then connecting with each other via existing video meeting platforms that are commercially available. However, none of the existing technologies that are routine, conventional and well-understood involves matchmaking capability that allows two or more people to match based on preferences and demographic data.

Second, existing technologies that are routine, conventional, and well-understood requires the participants of a gather to manually schedule a meeting with the other participants that they are interested in meeting. Unfortunately, the scheduling becomes more complex with several hundreds of participants are involved. Accordingly, none of the existing technologies that are routine, conventional, and well understood includes a centralized scheduling platform for scheduling hundreds or even thousands of discussion partners concurrently. Particularly, none of the routine, conventional, and well understood allow serial scheduling, where the video meeting platforms can for example schedule a series of 20 meetings with 20 different people for one individual and also do the same for 99 more people (or 99,000 more people) in a concurrent time slot.

Finally, existing technologies that are routine, conventional, and well-understood requires a person hosting the meeting to setup different meetings and end each meeting before starting another meeting. In other words, existing technologies requires a different meeting sign-in process for each meeting. However, none of the existing technologies that are routine, conventional, and well-understood allows the participants to seamlessly and automatically transition from their first pre-planned meeting to their last pre-planned meeting and all the intervening meetings and breaks with a single login, so that participants are free from timekeeping and navigation between meetings.

### SUMMARY

The disclosed technology involves a web-based program that is well integrated as a practical application that allows the user to design and execute scalable video meeting events between groups of entities (individuals or organizations) of a size and character that the user defines. Events consist of a number of concurrent meetings as defined by the user, taking place over a period of time required for the length and number of sequential time slots and breaks the user defines. The user also defines the maximum number of individual participants per entity per meeting. The disclosed technology aids the user in identifying individuals who meet certain demographic criteria, and supports recruitment of participants. The disclosed technology uses demographic data and participant preferences to determine the best matches and create a set meeting schedule. Particularly, the disclosed technology provides methods that are not routine, well-understood, and conventional where the participant experience is to log-in a single time for the entire event and then be taken automatically through a unique schedule of video meetings and breaks. Having logged in, each participant experiences conversations via video meetings with a series of carefully selected discussion partners with brief breaks in between. Transitioning from one meeting to the next is effortless and automatic, freeing participants from the burdens of navigation between meetings and timekeeping (they need to only take notice of the countdown clock.) Participants can rate their experience after each meeting, and at the end review the meeting ratings and decide how they would like for the new relationship to proceed or not proceed.

Embodiments provide a computer-implemented method for providing seamless video conferencing includes receiving a plurality of participants for a video conferencing session. A match between the plurality of participants for the video conferencing session is identified based on participant criteria. One or more meetings is scheduled sequentially between the matched participants. Participants only need to log in once to participate in the entire event.

In another embodiment, the plurality of participants automatically transitions from one meeting to another meeting in the scheduled one or more meetings without providing the session login data associated with the video conferencing session.

In yet another embodiment, a link is provided to the plurality of participants to join a first meeting of the scheduled one or more meetings.

In another embodiment, the plurality of participants can participate in all of the scheduled one or more meetings by clicking only once on the provided link.

In yet another embodiment, each of the scheduled one or more meetings has a predetermined time and wherein plurality of participants transition from one meeting to another meeting within the scheduled one or more meetings after expiration of the predetermined time.

In another embodiment, the scheduled one or more meetings occur between the match plurality of participants concurrently.

In another illustrative embodiment, a non-transitory computer readable medium comprising a computer usable or readable medium having a computer readable program is provided. The computer readable program, when executed on a processor, causes the processor to perform various ones of, and combinations of, the operations outlined above with regard to the method illustrative embodiment.

In yet another illustrative embodiment, a system is provided. The system may comprise a full question generation processor configured to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an exemplary network environment 10 including a video conferencing system 14 for providing a serial video conferencing system that automatically and seamlessly transitions users from one meeting to another;

FIG. 2 is a block diagram of an exemplary video conferencing system 14;

FIG. 3 is a flowchart illustrating an exemplary method 300 for providing a serial video conferencing system that automatically and seamlessly transitions users from one meeting to another; and

FIGS. 4-14 are exemplary images illustrating the method 300 for providing a serial video conferencing system that automatically and seamlessly transitions users from one meeting to another.

### DETAILED DESCRIPTION OF EXEMPLARY EMBODIMENTS

The present invention may be a system, a method, and/or a computer program product for refining dataset to provide a seamless video conferencing system. The computer program product may include a computer-readable storage medium (or media) having computer-readable program instructions thereon for causing a processor to carry out aspects of the present invention.

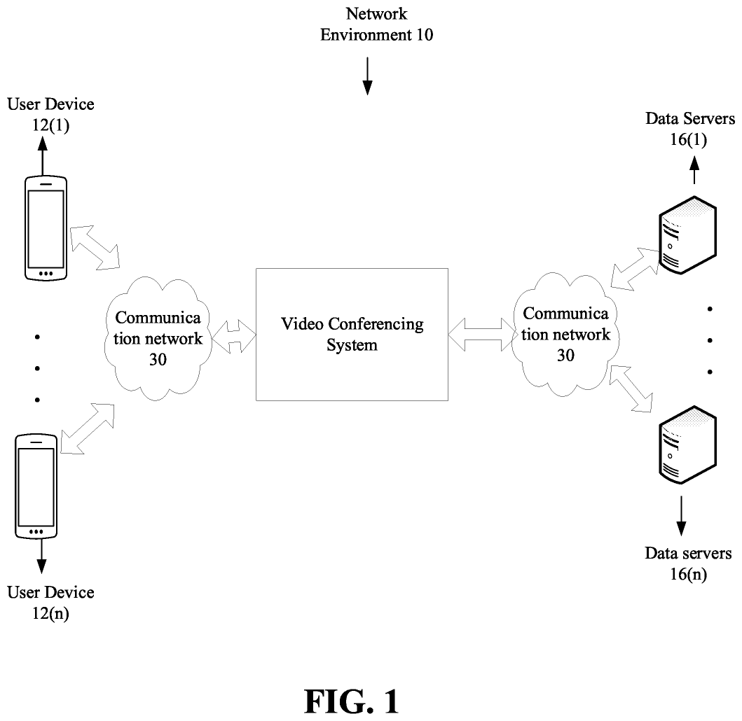

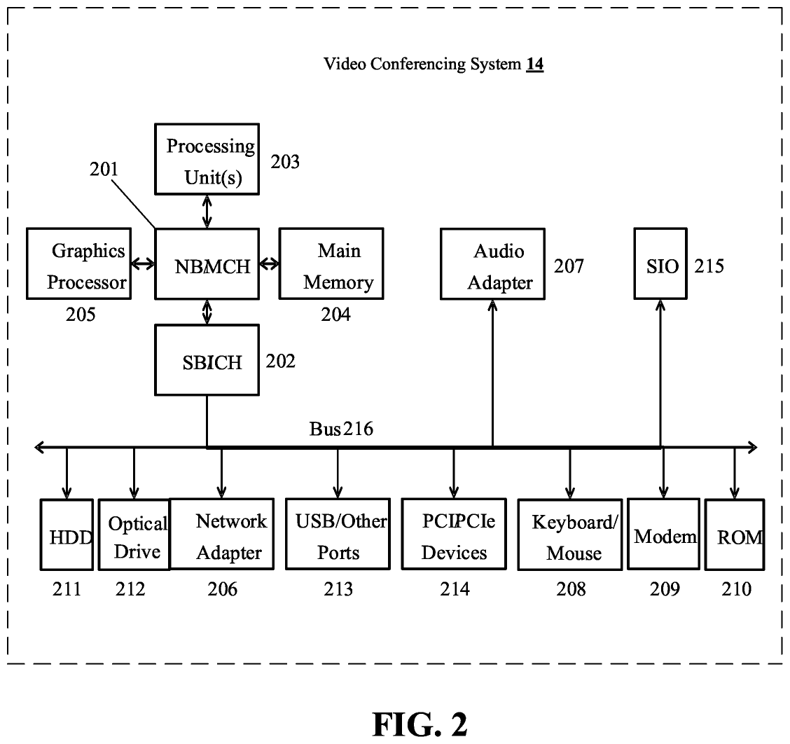

A network environment 10 with an example of a video conferencing system 14 is illustrated in FIGS. 1-2. In this particular example, the environment 10 includes one or more user devices 12(1)-12(n), the video conferencing system 14, and one or more data servers 16(1)-16(n), coupled via one or more communication networks 30, although the environment could include other types and numbers of systems, devices, components, and/or other elements as is generally known in the art and will not be illustrated or described herein. This technology provides a number of advantages including providing methods, non-transitory computer readable medium, and systems that provides a serial video conferencing system that automatically and seamlessly transitions users from one meeting to another.

Referring more specifically to FIGS. 1-2, the video conferencing system 14 is programmed to provide a serial video conferencing system that automatically and seamlessly transitions users from one meeting to another. Now referring to FIG. 2, the video conferencing system 14 can employ a hub architecture including a north bridge and memory controller hub (NB/MCH) 201 and south bridge and input/output (I/O) controller hub (SB/ICH) 202. Processing unit 203, main memory 204, and graphics processor 205 can be connected to the NB/MCH 201. Graphics processor 205 can be connected to the NB/MCH 201 through an accelerated graphics port (AGP).

In the depicted example, the network adapter 206 connects to the SB/ICH 202. The audio adapter 207, keyboard and mouse adapter 208, modem 209, read-only memory (ROM) 210, hard disk drive (HDD) 211, optical drive (CD or DVD) 212, universal serial bus (USB) ports and other communication ports 213, and the PCI/PCIe devices 214 can connect to the SB/ICH 702 through bus system 216. PCI/PCIe devices 214 may include Ethernet adapters, add-in cards, and PC cards for notebook computers. ROM 210 may be, for example, a flash basic input/output system (BIOS). The HDD 211 and optical drive 212 can use an integrated drive electronics (IDE) or serial advanced technology attachment (SATA) interface. The super I/O (SIO) device 215 can be connected to the SB/ICH.

An operating system can run on processing unit 203. The operating system can coordinate and provide control of various components within the video conferencing system 14. As a client, the operating system can be a commercially available operating system. An object-oriented programming system, such as the Java™ programming system, may run in conjunction with the operating system and provide calls to the operating system from the object-oriented programs or applications executing on the data processing system 700. As a server, the video conferencing system 14 can be an IBM® eServer™ System p® running the Advanced Interactive Executive operating system or the Linux operating system. The video conferencing system 14 can be a symmetric multiprocessor (SMP) system that can include a plurality of processors in the processing unit 203. Alternatively, a single processor system may be employed.

Instructions for the operating system, the object-oriented programming system, and applications or programs are located on storage devices, such as the HDD 211, and are loaded into the main memory 204 for execution by the processing unit 203. The processes for embodiments of the full question generation system can be performed by the processing unit 703 using computer usable program code, which can be located in a memory such as, for example, main memory 204, ROM 210, or in one or more peripheral devices.

A bus system 216 can be comprised of one or more busses. The bus system 216 can be implemented using any type of communication fabric or architecture that can provide for a transfer of data between different components or devices attached to the fabric or architecture. A communication unit such as the modem 209 or network adapter 206 can include one or more devices that can be used to transmit and receive data.

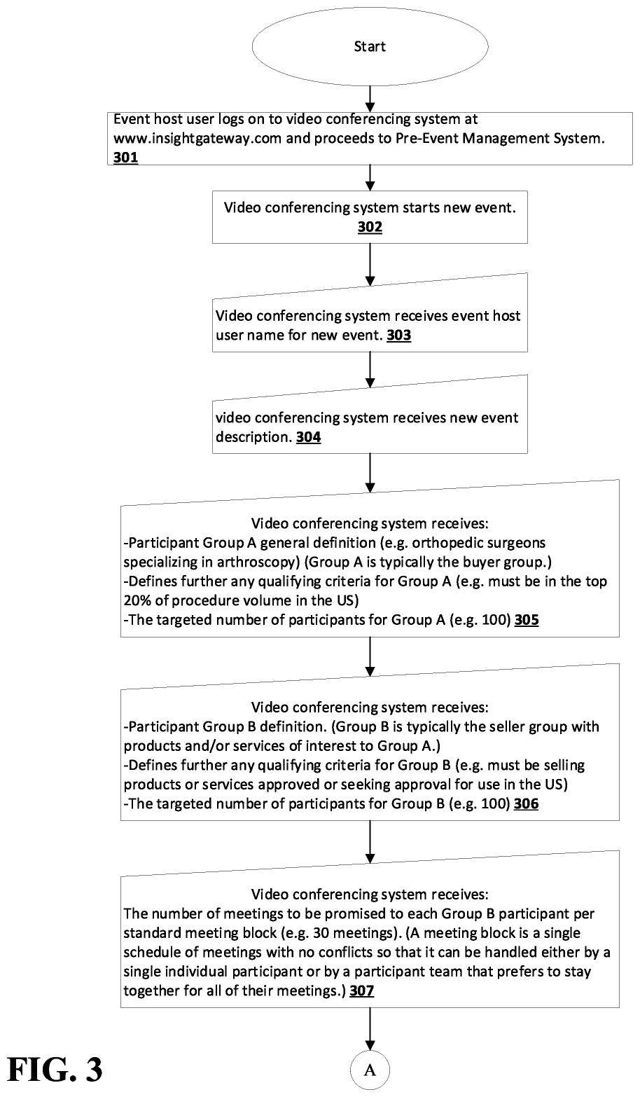

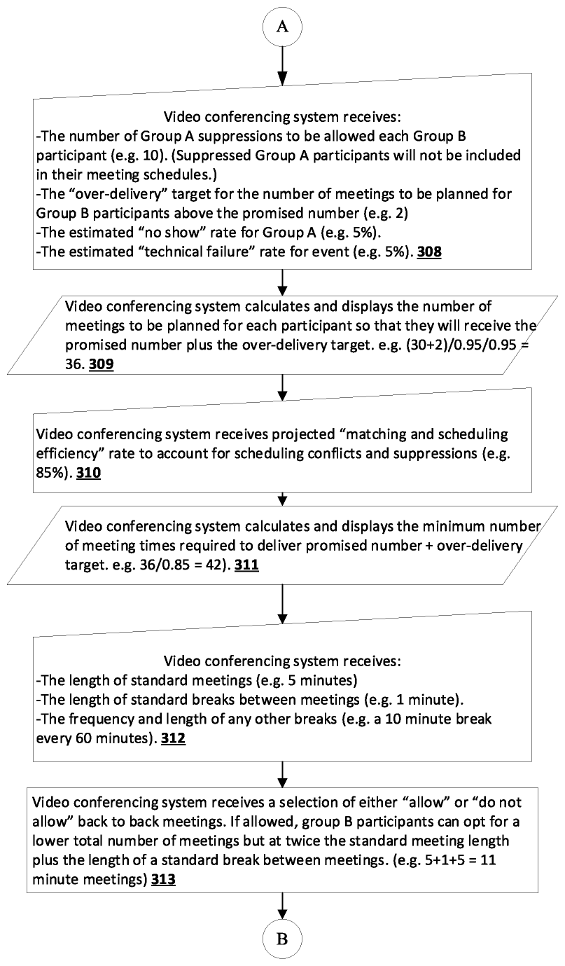

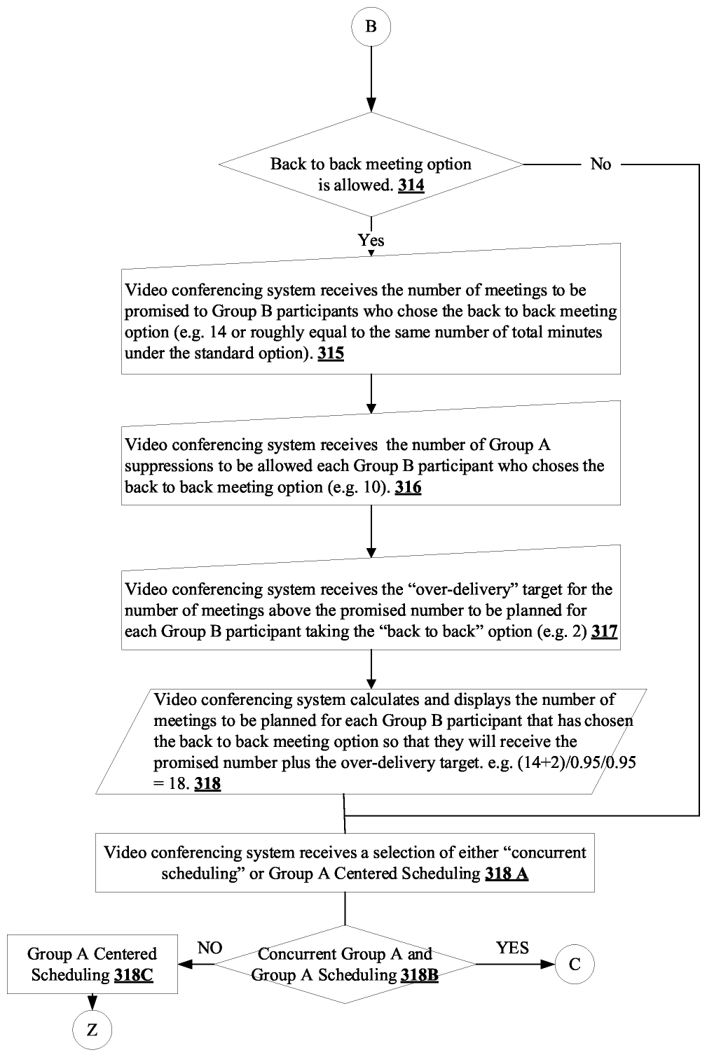

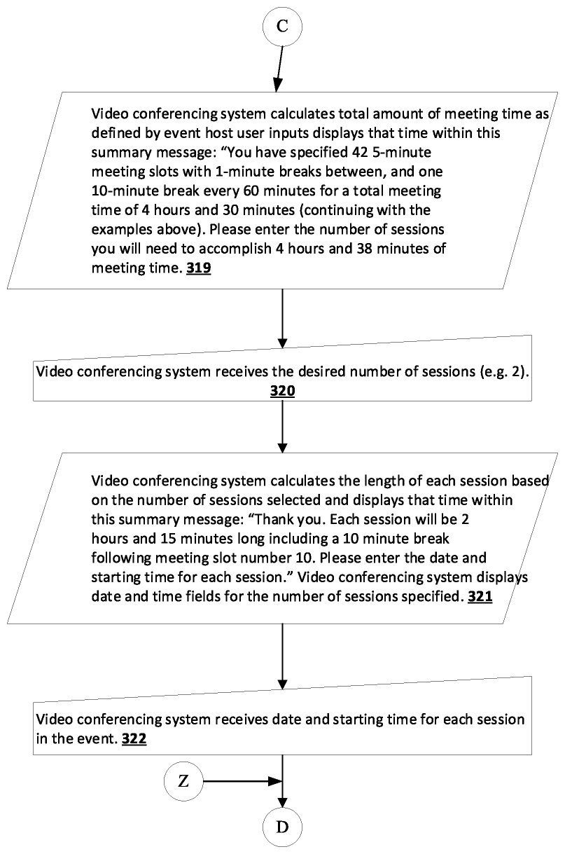

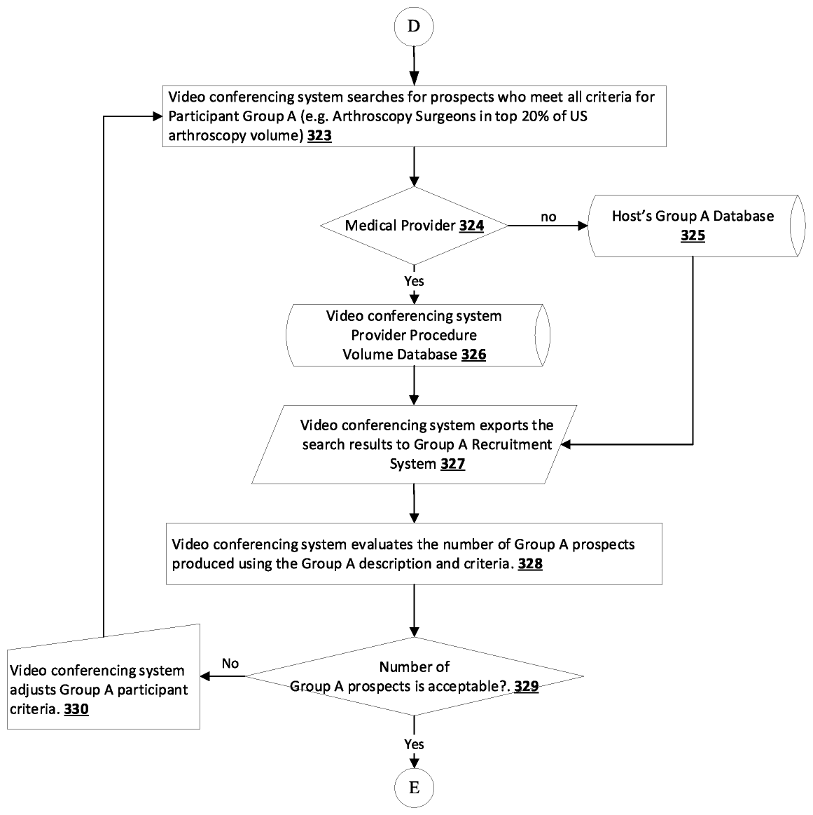

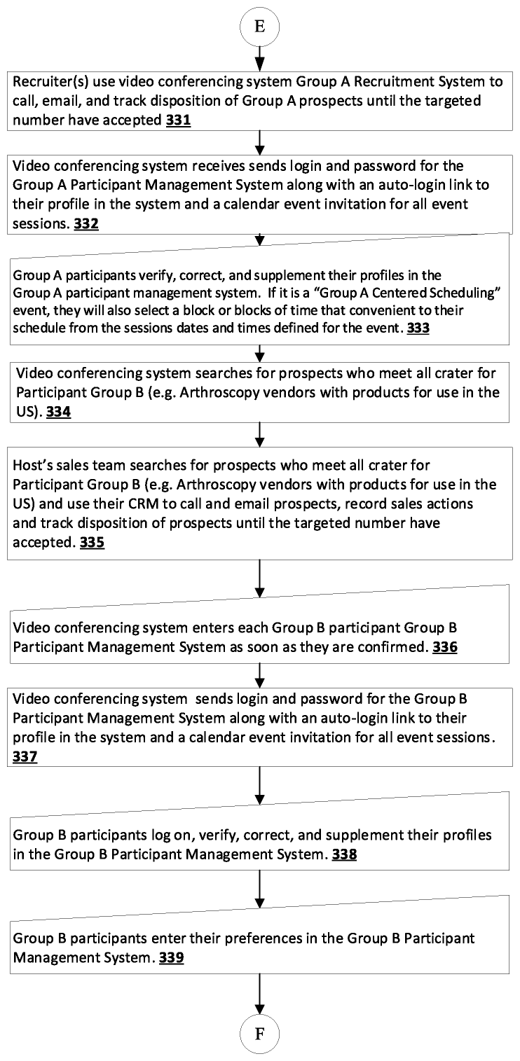

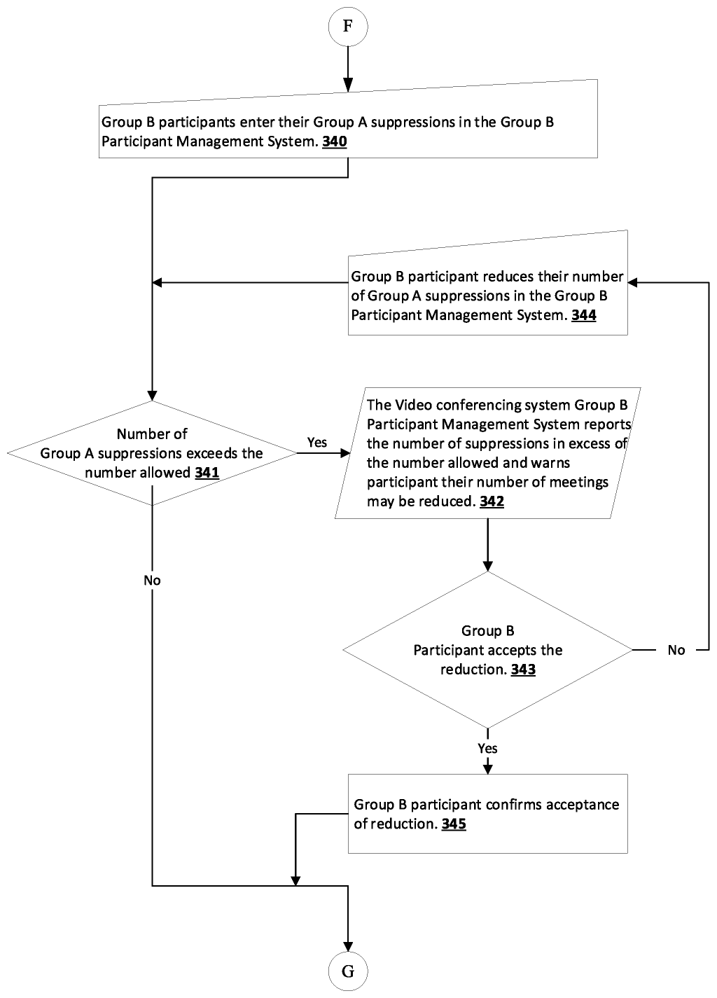

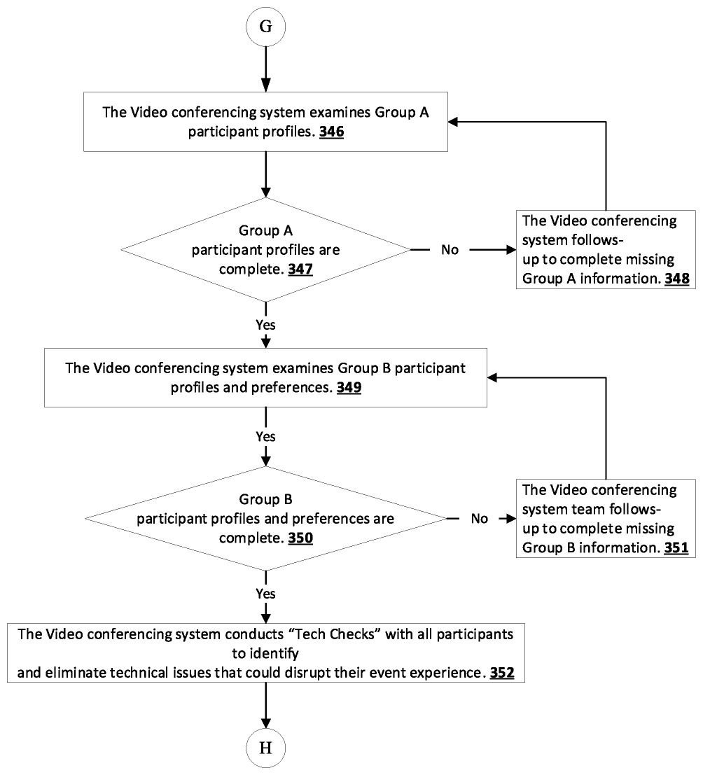

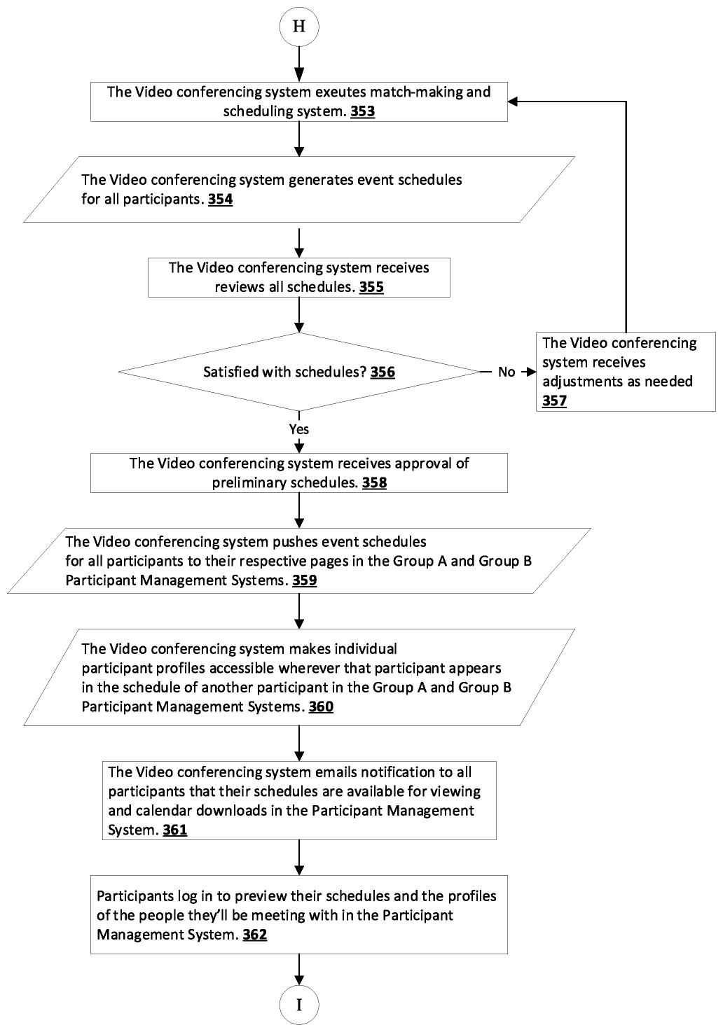

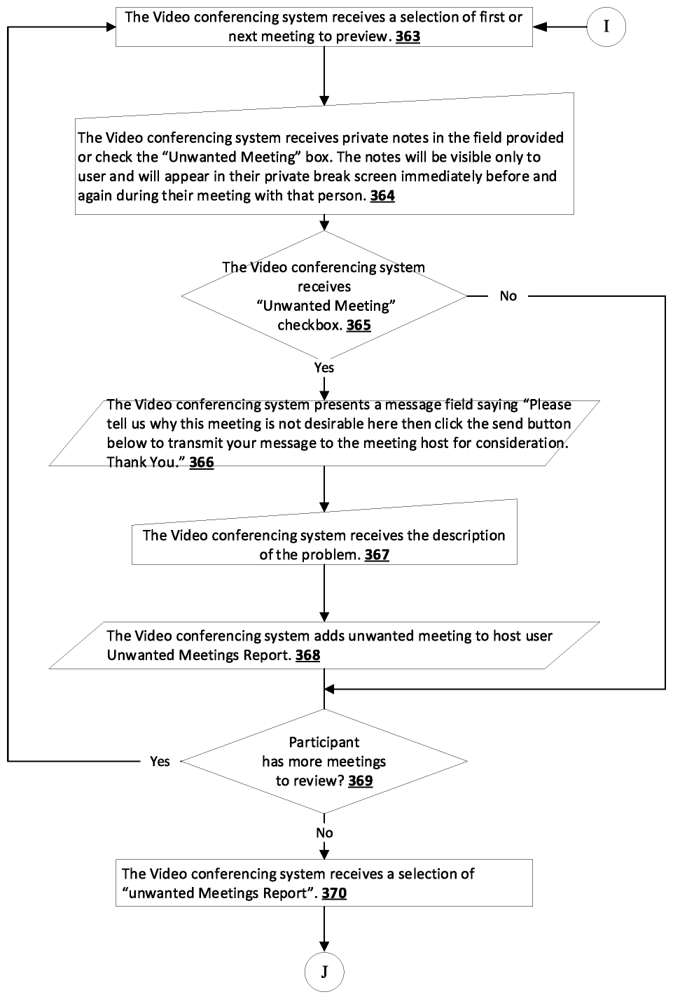

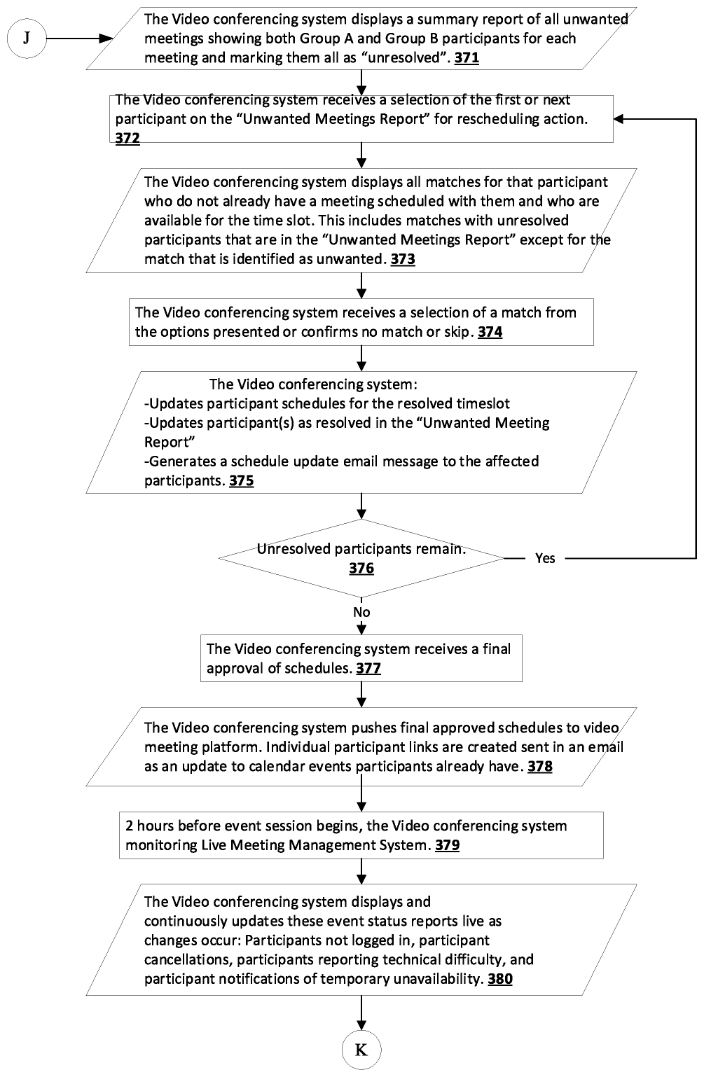

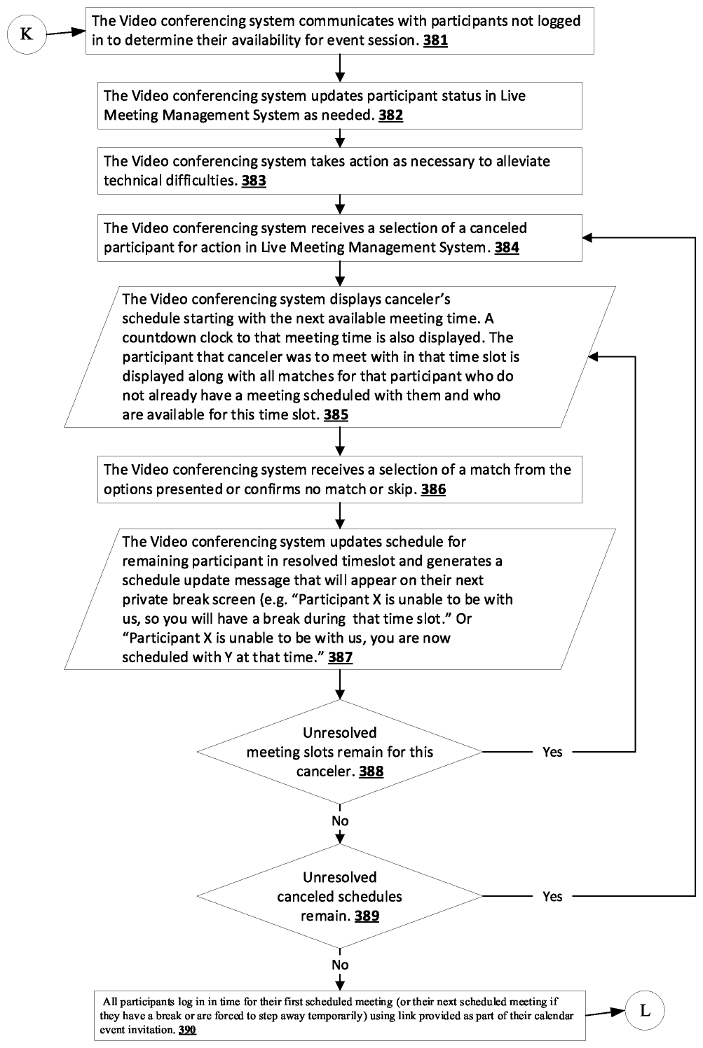

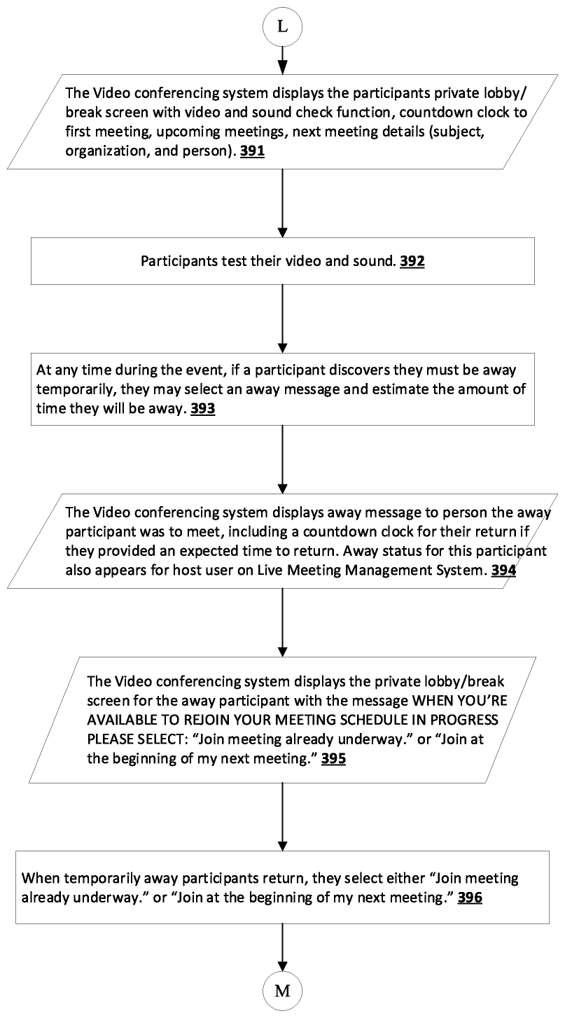

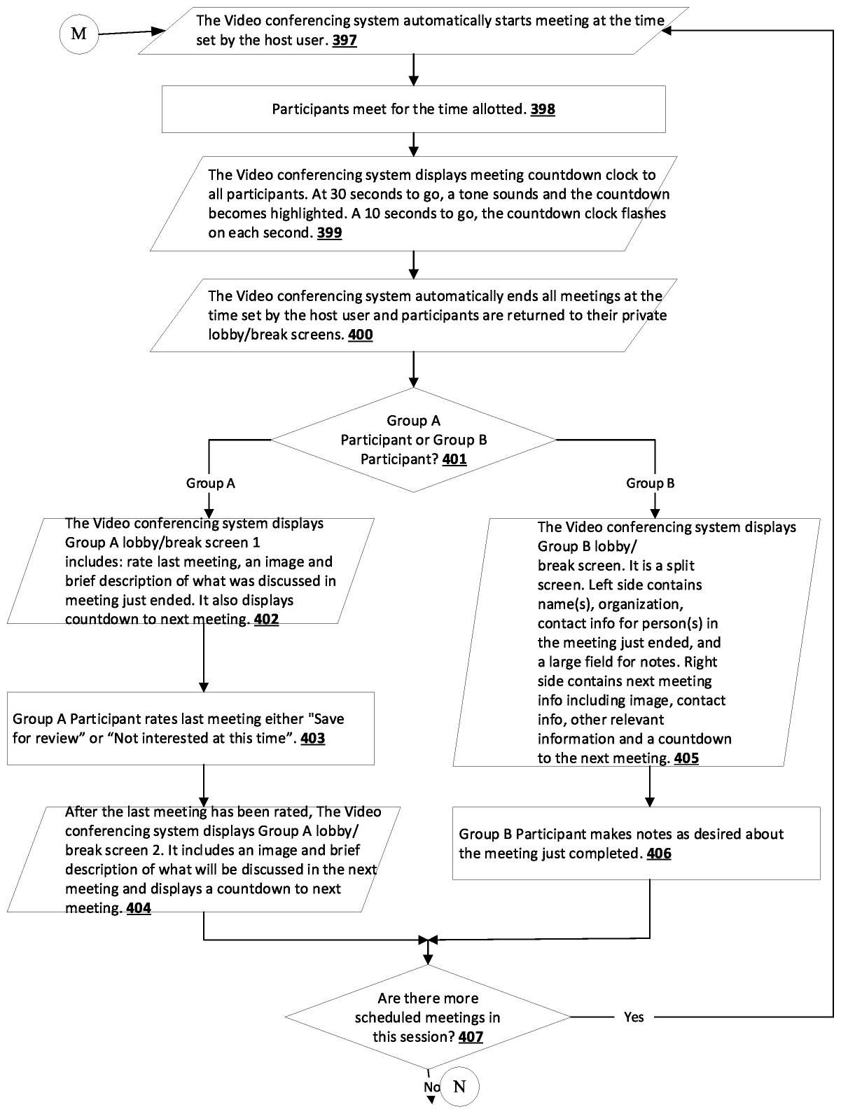

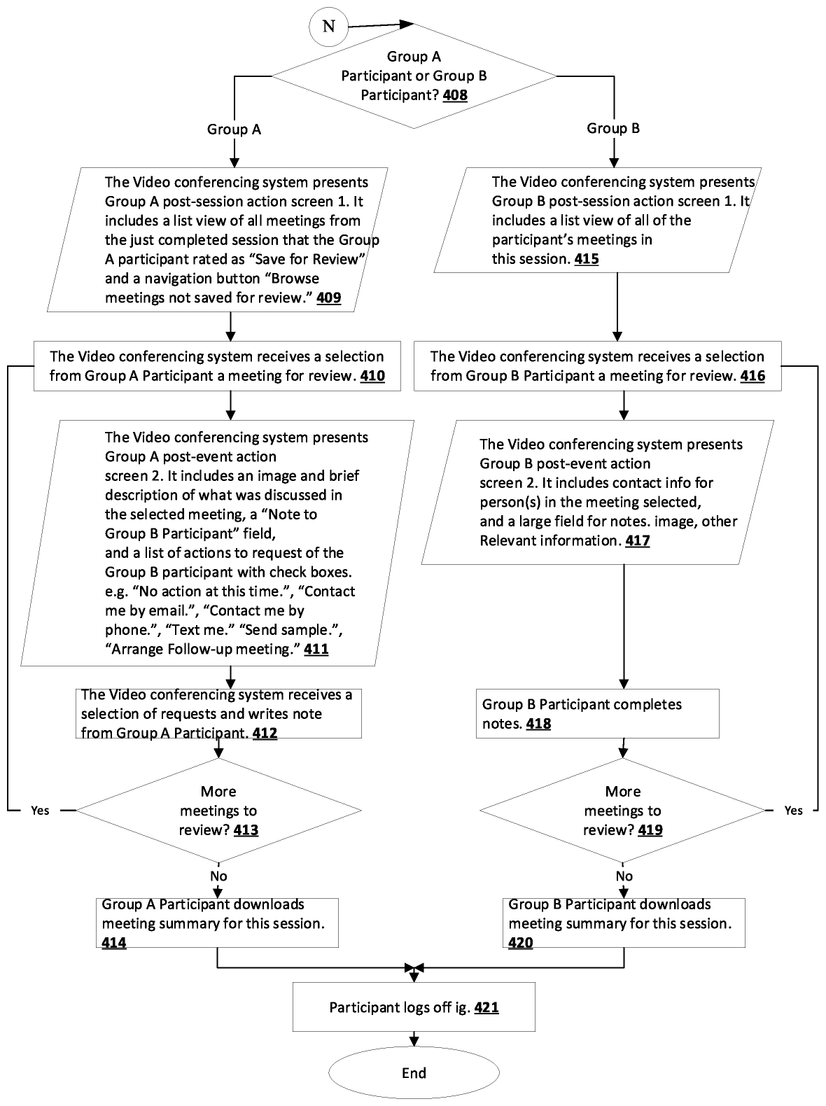

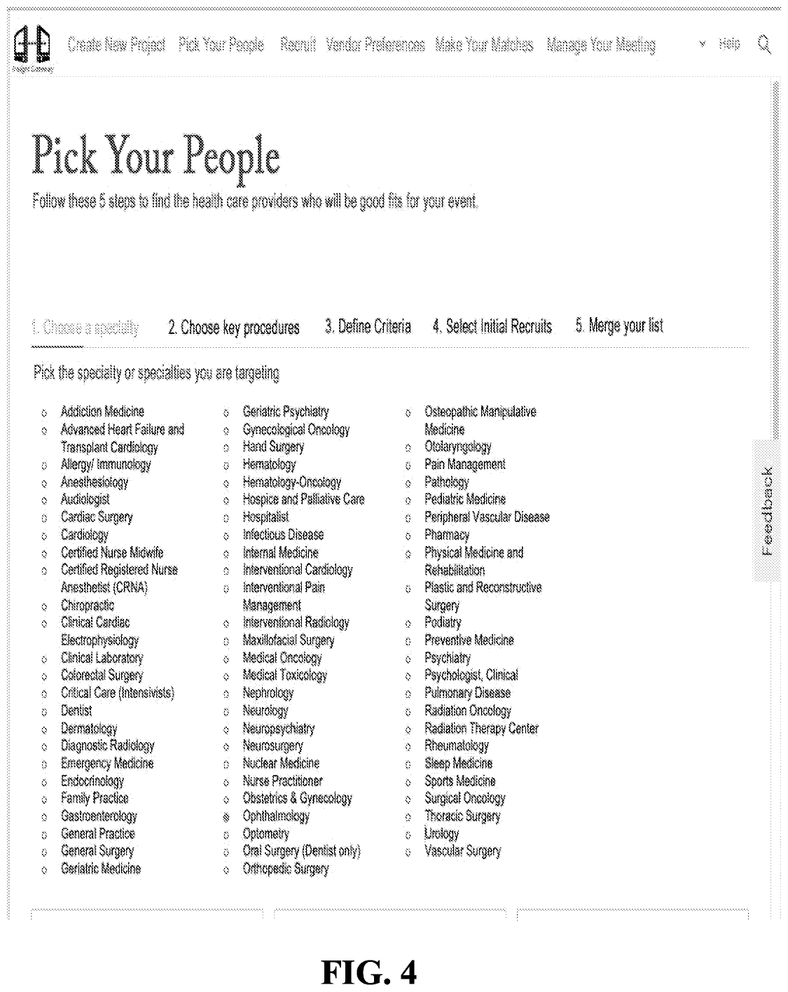

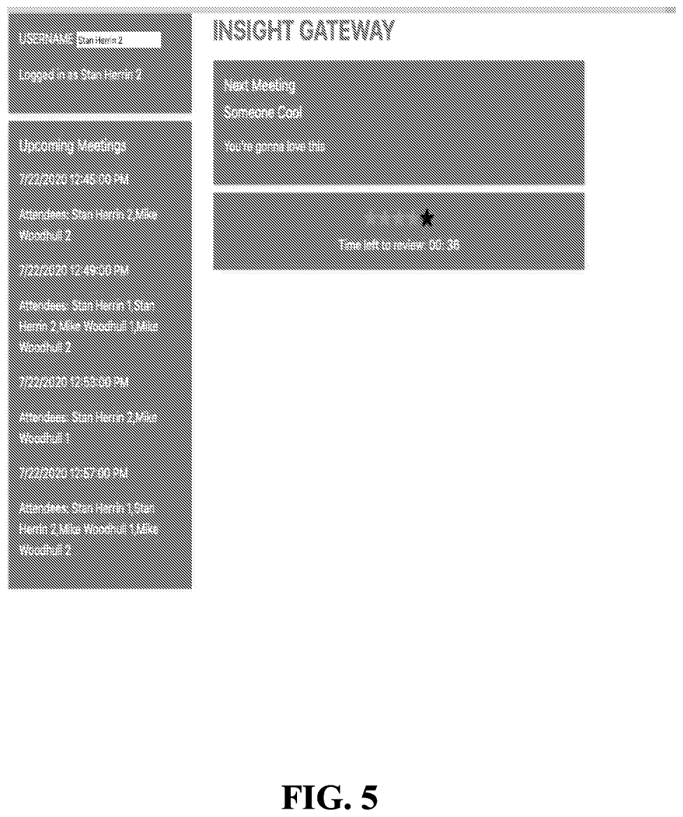

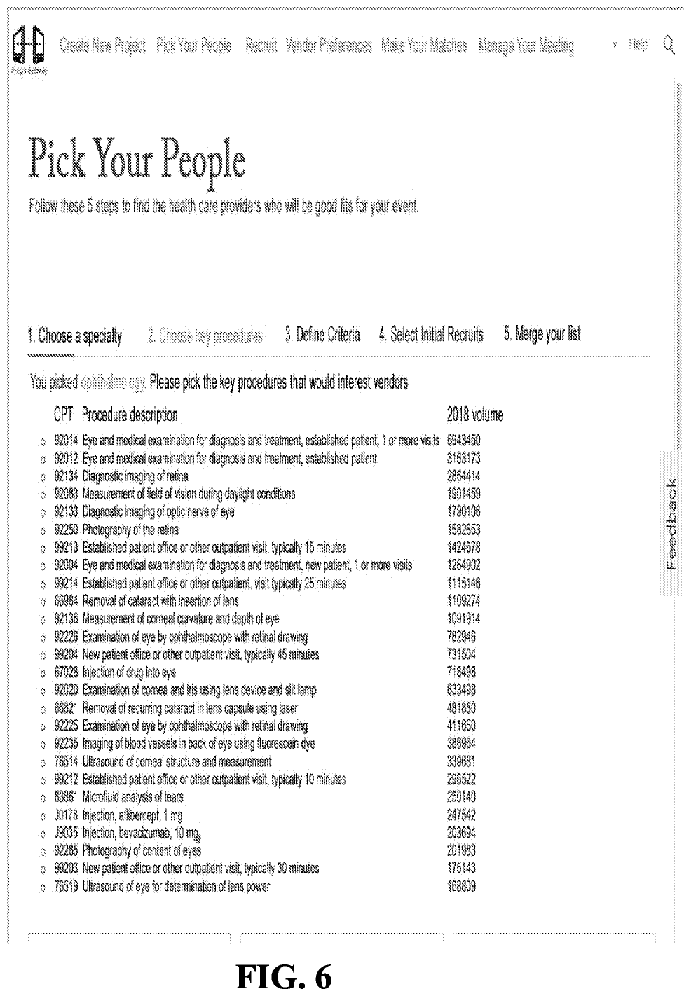

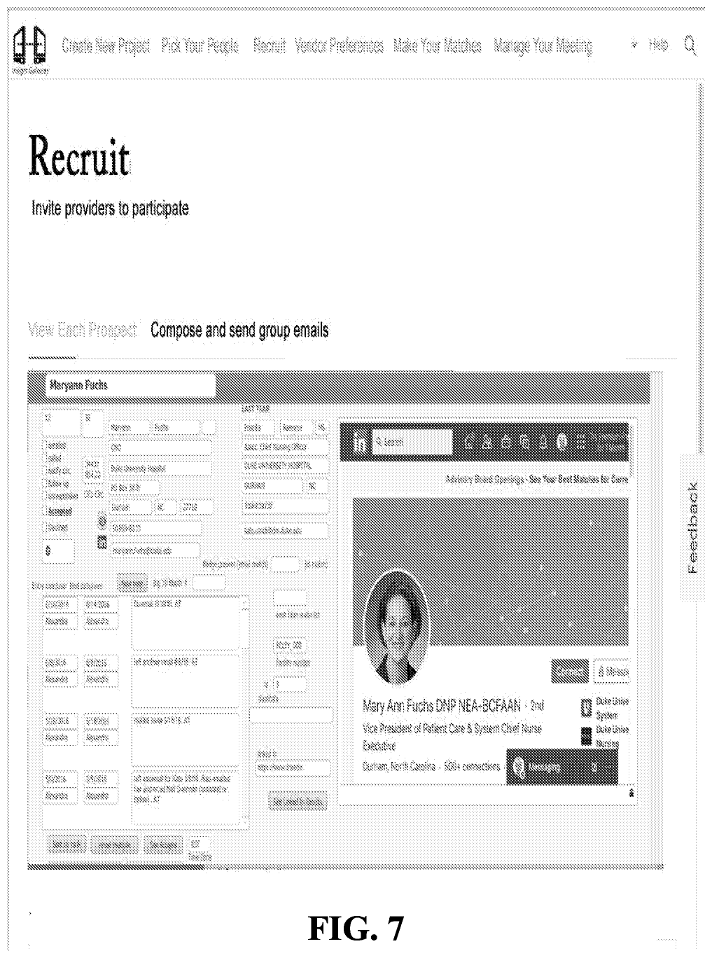

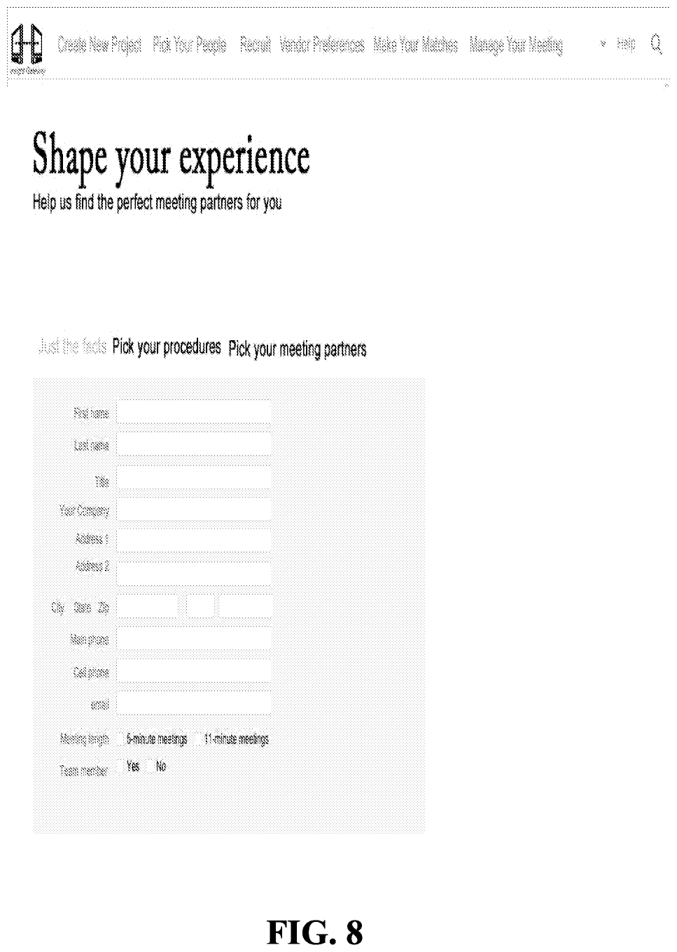

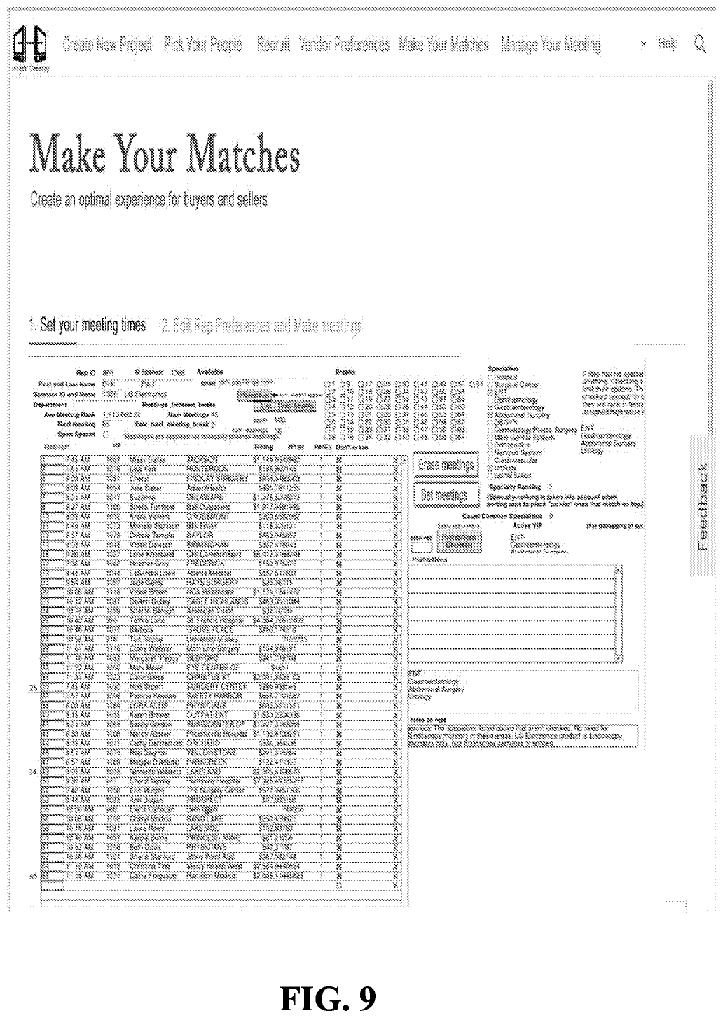

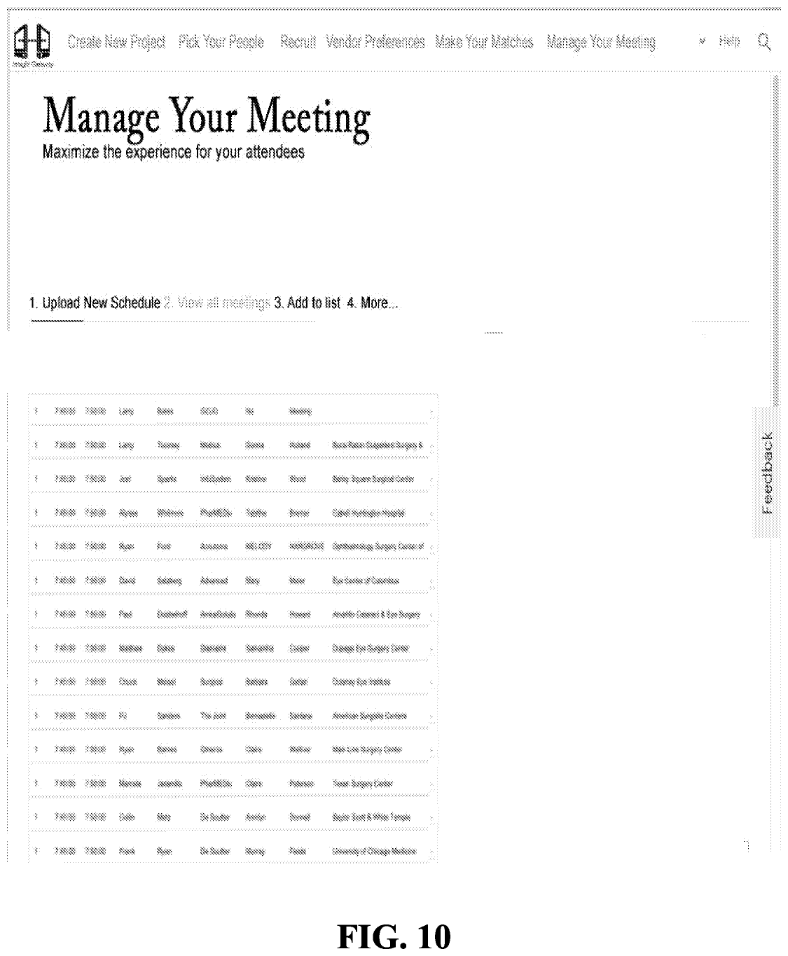

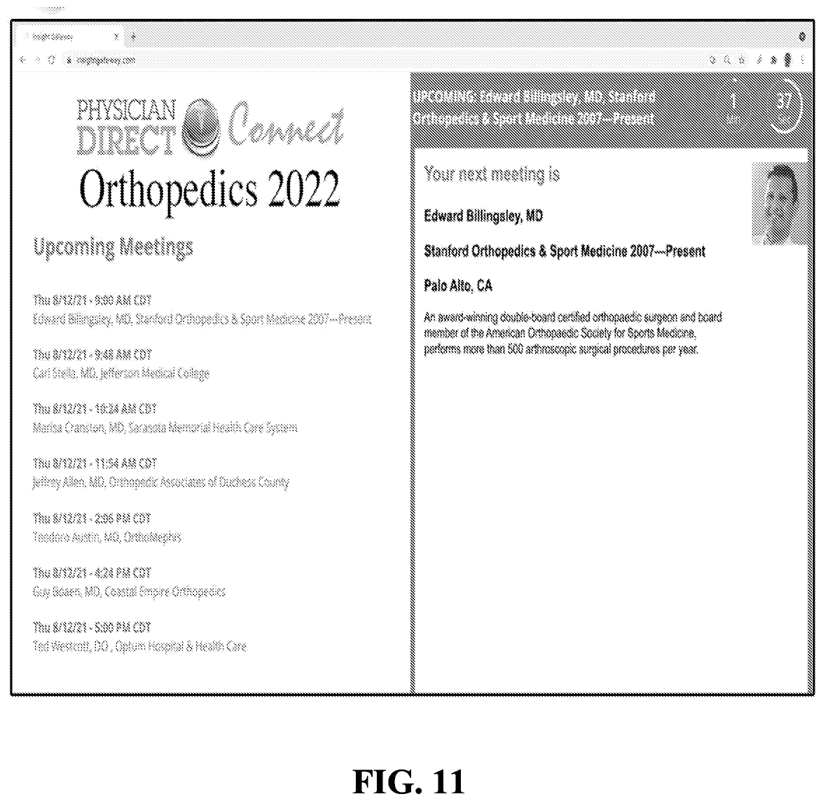

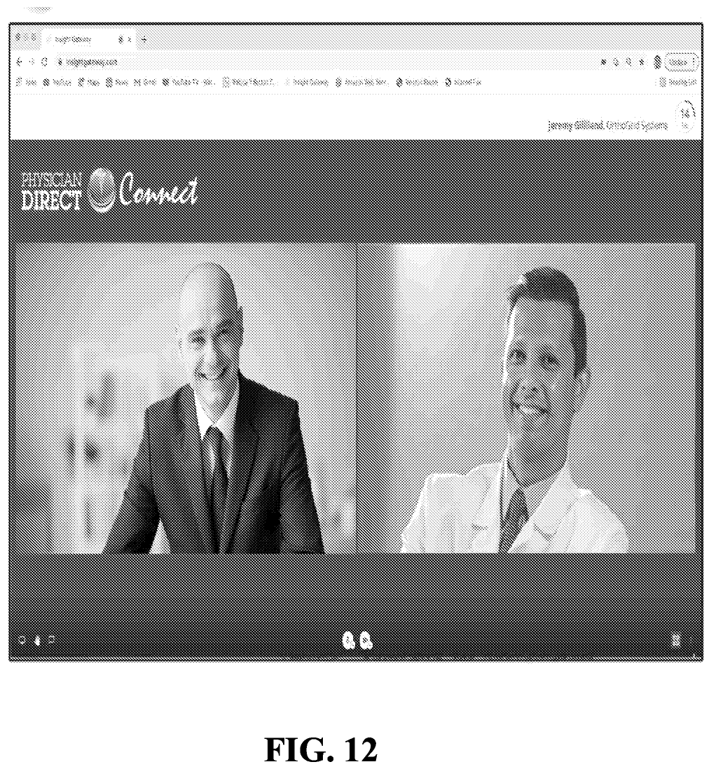

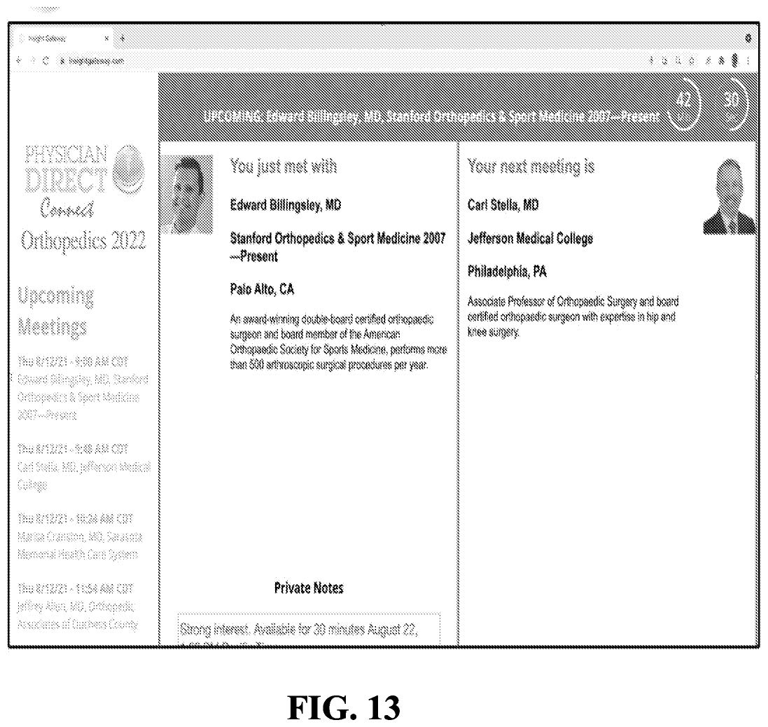

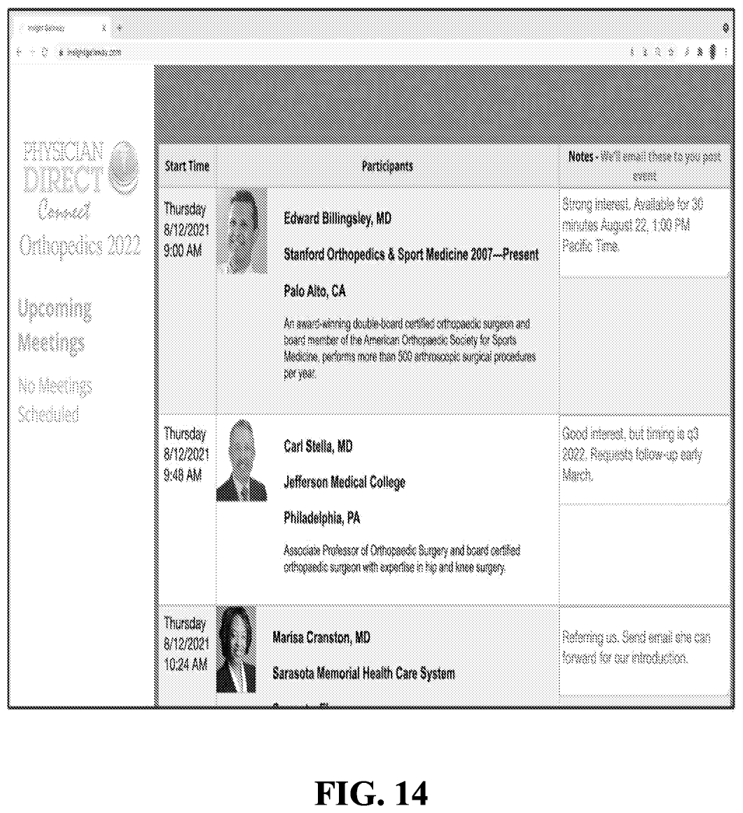

Those of ordinary skill in the art will appreciate that the hardware depicted in FIG. 2 may vary depending on the implementation. For example, the video conferencing system 14 includes several components that would not be directly included in some embodiments illustrated in FIGS. 3-14. However, it should be understood that the embodiments illustrated in FIGS. 3-14 may include one or more of the components and configurations of the video conferencing system 14 for performing processing methods and steps in accordance with the disclosed embodiments.

Moreover, other internal hardware or peripheral devices, such as flash memory, equivalent non-volatile memory, or optical disk drives may be used in addition to or in place of the hardware depicted. Moreover, the video conferencing system 14 can take the form of any of a number of different data processing systems, including but not limited to, client computing devices, server computing devices, tablet computers, laptop computers, telephone or other communication devices, personal digital assistants, and the like. Essentially, video conferencing system 14 can be any known or later developed data processing system without architectural limitation.

Referring back to FIG. 1, each of the one or more user devices 12(1)-12(n) may request for scheduling video conferencing to the video conferencing system 14 via one or more of the communication networks 30, for example, although other types and/or numbers of storage media in other configurations could be used. In this particular example, each of the one or more user devices 12(1)-12(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the one or more user devices 12(1)-12(n) and may transmit data in response to requests from the video conferencing system 14. Each the one or more one or more user devices 12(1)-12(n) may include a processor, a memory, and a communication interface, which are coupled together by a bus or other link, although each may have other types and/or numbers of other systems, devices, components, and/or other elements.

Next, each of the one or more data servers 16(1)-16(n) may store and provide data to the video conferencing system 14 via one or more of the communication networks 30, for example, although other types and/or numbers of storage media in other configurations could be used. In this particular example, each of the one or more data servers 16(1)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the one or more data servers 16(1)-16(n) and may transmit data in response to requests from the video conferencing system 14. Each the one or more data servers 16(1)-16(n) may include a processor, a memory, and a communication interface, which are coupled together by a bus or other link, although each may have other types and/or numbers of other systems, devices, components, and/or other elements.

The non-transitory computer readable storage medium can be a tangible device that can retain and store instructions for use by an instruction execution device. The non-transitory computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A non-transitory computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The non-transitory computer readable program instructions described herein can be downloaded to respective computing/processing devices from a computer readable storage medium or to an external computer or external storage device via a communication network 30, for example, the Internet, a local area network (LAN), a wide area network (WAN) and/or a wireless network. The communication network 30 may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of communication network 30, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present description and claims may make use of the terms “a,” “at least one of,” and “one or more of,” with regard to particular features and elements of the illustrative embodiments. It should be appreciated that these terms and phrases are intended to state that there is at least one of the particular features or elements present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The system and processes of the Figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112 (f), unless the element is expressly recited using the phrase “means for.”

An exemplary method for providing a serial video conferencing system that automatically and seamlessly transitions users from one meeting to another will now be illustrated with reference to FIGS. 3-14. The exemplary method 300 begins at step 301 where the event host user via one of the user devices 12(1) logs on to session hosted on the video conferencing system 14 via a website and proceeds to Pre-Event Management System.

In step 302, the video conferencing system 14 starts a new event. A new event in this example can be a new video conferencing scheduling event.

In step 303, the video conferencing system 14 creates a new name for the event.

In step 304, the video conferencing system 14 completes the event description based on the data received from the user using the user device 12(1), although the event description can be completed using other techniques.

In step 305, the video conferencing system 14 receives data associated with the event from the user device 12(1). By way of example, the data received from the user device 12(1) can include participant Group A (buyer group) general definition (e.g., orthopedic surgeons specializing in arthroscopy) and any qualifying criteria for Group A (e.g., must be in the top 20% of procedure volume in the US) along with the targeted number of participants for Group A.

In step 306, the video conferencing system 14 receives additional data associated with the event from the user device 12(1) participant Group B definition. (Group B is typically the seller group with products and/or services of interest to Group A.) and any qualifying criteria for Group B (e.g., must be selling products or services approved or seeking approval for use in the US) along with the targeted number of participants for Group B.

In step 307, the video conferencing system 14 receives further information associated with the event such as the number of meetings to be promised to each Group B participant per standard meeting block (e.g., 30 meetings). (A meeting block is a single schedule of meetings with no conflicts so that it can be handled either by a single individual participant or by a participant team that prefers to stay together for all of their meetings.)

In step 308, the video conferencing system 14 receives rules for the video conferencing such as number of Group A suppressions to be allowed each Group B participant (e.g., 10). (Suppressed Group A participants will not be included in their meeting schedules.); the “over-delivery” target for the number of meetings to be planned for Group B participants above the promised number (e.g., 2); the estimated “no show” rate for Group A (e.g., 5%); and the estimated “technical failure” rate for event (e.g., 5%), although other types of video conferencing rules can be received by the video conferencing system 14.

In step 309, the video conferencing system 14 calculates and displays the number of meetings to be planned for each participant so that they will receive the promised number plus the over-delivery target—e.g., (30+2)/0.95/0.95=36.

In step 310, the video conferencing system 14 receives the projected “matching and scheduling efficiency” rate to account for scheduling conflicts and suppressions (e.g., 85%) from the user device 12(1).

In step 311, the video conferencing system 14 calculates and displays the minimum number of meeting times required to deliver promised number+over-delivery target. For example, 36/0.85=42.

In step 312, the video conferencing system 14 receives the length of standard meetings (e.g., 5 minutes), the length of standard breaks between meetings (e.g., 1 minute), and the frequency and length of any other breaks (e.g., a 10 minute break every 60 minutes) from the user device 12(1).

In step 313, the video conferencing system 14 receives a selection of either “allow” or “do not allow” back to back meetings from the user device 12(1). In this example, if allowed, group B participants can opt for a lower total number of meetings but at twice the standard meeting length plus the length of a standard break between meetings. (e.g., 5+1+5=11 minute meetings).

In step 314, the video conferencing system 14 determines if back to back meeting is allowed based on the data received from the user device 12(1), although other techniques can be used to make the determination. If the video conferencing system 14 determines that back to back meetings are not allowed, then the No branch is taken to step 319 which will be further illustrated below. However, if the video conferencing system 14 determines that back to back meeting option is allowed, then the Yes branch is taken to step 315.

In step 315, the video conferencing system 14 receives the number of meetings to be promised to Group B participants who chose the back to back meeting option (e.g., 14 or roughly equal to the same number of total minutes under the standard option) from the user device 12(1).

In step 316, the video conferencing system 14 receives the number of Group A suppressions to be allowed each Group B participant who chooses the back to back meeting option (e.g., 10) from the user device 12(1).

In step 317, the video conferencing system 14 receives the “over-delivery” target for the number of meetings above the promised number to be planned for each Group B participant taking the “back to back” option (e.g., 2) from the user device 12(1).

In step 318, the video conferencing system 14 calculates and displays the number of meetings to be planned for each Group B participant that has chosen the back to back meeting option so that they will receive the promised number plus the over-delivery target—e.g., (14+2)/0.95/0.95=18.

In step 318A, the video conferencing system 14 receives a selection of either concurrent scheduling or Group A centered scheduling.

Next, in step 318B, the video conferencing system 14 determining if the received selection is a concurrent scheduling or a Group A centered scheduling. Accordingly, if the video conferencing system 14 determines that it is a Group A centered scheduling, then the No branch is taken to step 318C.

In step 318C, the video conferencing system 14 calculates the total amount of meeting time as defined by event host user inputs, and displays that time within a summary message. e.g. “You have specified Group A Centered Scheduling for 42 5-minute meeting slots with 1-minute breaks between. The total meeting time required=4 hours and 30 minutes (continuing with the examples above). Please enter the number of sessions you will make available to accomplish 4 hours and 30 minutes of meeting time. Alternatively, the video conferencing system 14 can receive the desired number of sessions from the event host users. In another example, the video conferencing system 14 can display date and time fields for the number of sessions specified. In yet another example, the video conferencing system 14 can receive the dates and time periods available for each session of the event. (Note: Under Group A Centered Scheduling, a “session” is a defined period of time that is available for meetings. Under Group A Centered Scheduling, individual Group A participants will select a block or blocks of time to participate within the sessions defined here by the Event Host User.)

In step 319, the video conferencing system 14 calculates total amount of meeting time as defined by event host user inputs displays that time within this summary message: “You have specified 42 5-minute meeting slots with 1-minute breaks between, and one 10-minute break every 60 minutes for a total meeting time of 4 hours and 38 minutes (continuing with the examples above). The video conferencing system also receives the number of sessions that needs to be accomplished in 4 hours and 38 minutes of meeting time.

In step 320, the video conferencing system 14 receives the desired number of sessions (e.g., 2) from the user device 12(1).

In step 321, the video conferencing system 14 calculates the length of each session based on the number of sessions selected and displays that time within this summary message: “Thank you. Each session will be 2 hours and 14 minutes long including a 10 minute break following meeting slot number 10. Please enter the date and starting time for each session.” Further, the video conferencing system 14 displays date and time fields for the number of sessions specified.

In step 322, the video conferencing system 14 receives date and starting time for each session in the event.

In step 323, the video conferencing system 14 receives search requests from the user device 12(1) for searching prospects who meet all criteria for participant Group A (e.g., Arthroscopy Surgeons in top 20% of US arthroscopy volume).

Next in step 324, the video conferencing system 14 determines if the search is for a medical provider. Accordingly, if the video conferencing system 14 determines that the search is not for a medical provider, then the No branch is taken to step 325 where the data in the host's group A database is provided to the user device 12(1). However, if the video conferring system 14 determines that the search is for a medical provider, then the Yes branch is taken to step 326.

In step 326, the video conferencing system 14 provides the data in the procedure volume database.

In step 327, the video conferencing system 14 receives the search results exported to the group A recruitment system.

In step 328, the video conferencing system 14 receives an evaluation of the number of Group A prospects produced using the Group A description and the criteria from the user device 12(1).

In step 329, the video conferencing system 14 determines if the number of Group A prospects is acceptable to the event host user. If the video conferencing system 14 determines that the number of group A prospects is not acceptable to the user, then the No branch is taken to step 330. In step 330, the video conferencing system 14 receives adjust regarding the criteria for a Group A participant from the user device 12(1). However, if the video conferencing system 14 determines that number of Group A prospects is acceptable to the event host user, then the Yes branch is taken to step 331.

In step 331, the video conferencing system 14 sends the Group A recruitment data to a recruiter using the user device 12(1) to call, email and track disposition of Group A prospects until the targeted number have accepted.

In step 332, the video conferencing system 14 receives a login and password for the Group A participant management system along with an auto-login link to their profile in the system and a calendar invitation for all event sessions from the user device 12(1).

In step 333, the video conferencing system 14 receives a verification of the data associated with the Group A participants. Further, if there are any corrections required, the video conferencing system 14 receives the supplemental data from the user device 12(1). If it is a “Group A Centered Scheduling” event, they will also select a block or blocks of time that convenient to their schedule from the sessions dates and times defined for the event.

In step 334, the video conferencing system 14 receives a search request to search for all prospects who meet all criteria for participant group B (e.g., arthroscopy vendors with products for us in the US).

In step 335, the video conferencing system 14 receives another search request for prospects who meet all the criteria for participant group B (e.g., arthroscopy vendors with products for use in the US). Additionally, the video conferencing system 14 receives data associated with calls made and emails sent to prospects via the customer relationship management to call and email prospects, record sales actions and track dispositions of prospects until the targeted number has been accepted.

In step 336, the video conferencing system 14 video conferencing system 14 receives the Group B participant into the Group B participant management system as soon as a confirmation is received from the user device 12(1).

In step 337, the video conferencing system 14 receives a login and password for the Group B participant management system along with an auto-login link to their profile in the system and a calendar event invitation for all event sessions from the user device 12(1).

In step 338, the Group B participants' logs on to the video conferencing system 14 using the user device 12(1) and verifies their data or supplements their profiles with correct data.

In step 339, the video conferencing system 14 receives the user's preference in the Group B participant management system from the user device 12(1).

In step 340, the video conferencing system 14 receives data associated with group B participants and their corresponding group A suppressions in the Group B from the participant management system.

Next in step 341, the video conferencing system 14 determines if the number of Group A suppressions exceeds the number allowed. If the video conferencing system 14 determines that the Group A suppressions exceeds the number allowed, then the Yes branch is taken to step 342.

In step 342, the video conferencing system 14 reports the number of suppressions in excess of the number allowed and warns participant their number of meetings may be reduced and the flow proceeds to step 343.

In step 343, the video conferencing system 14 determines if the group B participant access the reduction in the number of meetings. If the video conferencing system 14 determines that the reduction in the number of meetings is not accepted, then the No branch is taken to step 344.

In step 344, the video conferencing system 14 reduces the number of Group A suppressions in the Group B participant management system and the flow proceeds to step 341 that is illustrated above.

However back in step 343, if the video conferencing system 14 determines that group B participant accepts the reduction, then the Yes branch is taken to step 345.

In step 345, the video conferencing system 14 receives a confirmation from the Group B participant regarding the reduction of the meeting and the exemplary flow proceeds to step 346. Additionally, back in step 341, if the video conferencing system 14 determines that the number of Group A suppressions does not exceed the number allowed, then the No branch is taken to step 346.

In step 346, the video conferencing system 14 provides the profiles of the Group A participant so that the user device 12(1) can examine the profiles.

In step 347, the video conferencing system 14 determines if the Group A participant profiles are completed. If the video conferencing system 14 determines that the participant profiles are not complete, then the No branch is taken to step 348.

In step 348, the video conferencing system 14 requests the Group A participants to complete their profile information and the exemplary flow proceeds to step 346.

However, back in step 347, if the video conferencing system 14 determines that the Group A participant profiles are completed, then the Yes branch is taken to step 349.

In step 349, the video conferencing system 14 examines Group B participant profiles and preferences.

In step 350, the video conferencing system 14 determines if the Group B participant profiles and preferences are completed. If the video conferencing system 14 determines that the Group B participant profiles are not complete, then the No branch is taken to step 351.

In step 351, the video conferencing system 14 requests the Group B participants to complete the missing information and the exemplary flow proceeds to step 349.

However, back in step 350, if the video conferencing system 14 determines that the Group B participant information is complete, then the Yes branch is taken to step 352.

In step 352, the video conferencing system 14 performs a tech check to identify and eliminate all technical issues for all the participants that could disrupt their event experience.

In step 353, the video conferencing system 14 performs a match-making to schedule the meetings between the Group A and the Group B participants.

In step 354, the video conferencing system 14 generates an event schedules for all participants.

In step 355, the video conferencing system 14 performs a final review of the generated event schedule.

In step 356, the video conferencing system 14 determines if the final review is satisfactory. If the video conferencing system 14 determines that the final review is not satisfactory, then the No branch is taken to step 357.

In step 357, the video conferencing system 14 makes necessary adjustments to the generated event schedules.

However, back in step 356, if the video conferencing system 14 determines that the final review is satisfactory, then the Yes branch is taken to step 358.

In step 358, the video conferencing system 14 confirms the generated event schedule.

In step 359, the video conferencing system 14 pushes event schedules for all participants to their respective pages in the Group A and Group B Participant Management Systems.

In step 360, the video conferencing system 14 makes individual participant profiles accessible wherever that participant appears in the schedule of another participant in the Group A and Group B Participant Management Systems.

In step 361, the video conferencing system 14 sends a notification to all participants that their schedules are available for viewing and calendar downloads in the Participant Management System.

In step 362, the video conferencing system 14 provides the participants with a login to preview their schedules and the profiles of the people they'll be meeting with in the Participant Management System.

In step 363, the video conferencing system 14 provides a review of the first meeting or the next meeting for the user device 12(1) to select.

In step 364, the video conferencing system 14 receives private notes in the field provided or check the “Unwanted Meeting” box from the user device 12(1). In this example, the received notes will be visible only to themselves and will appear in their private break screen immediately before and again during their meeting with that person.

In step 365, the video conferencing system 14 determines if it is received a selection of the “unwanted meeting” box. If the video conferencing system 14 determines that it has not received the selection of the “unwanted meeting” box, then the No branch is taken to step 369 which will be further illustrated below. However, if the video conferencing system 14 determines that it has received a selection of the “unwanted meeting” box for at least one of the meetings, then the Yes branch is taken to step 366.

In step 366, the video conferencing system 14 provides a message field saying “Please tell us why this meeting is not desirable here then click the send button below to transmit your message to the meeting host for consideration. Thank You.”

In step 367, the video conferencing system 14 receives a description of the problem from the user device 12(1).

In step 368, the video conferencing system 14 adds unwanted meeting to host user Unwanted Meetings Report.

In step 369, the video conferencing system 14 determines if the participant has more meetings to review. If the video conferencing system 14 determines that there are more meetings to review, then the Yes branch is taken to step 363. However, if the video conferencing system 14 determines that the participant has no more meetings to review, then the No branch is taken to step 370.

In step 370, the video conferencing system 14 receives a selection of “unwanted Meetings Report” in Match-making and Scheduling System.

In step 371, the video conferencing system 14 displays a summary report of all unwanted meetings showing both Group A and Group B participants for each meeting and marking them all as “unresolved”.

In step 372, the video conferencing system 14 receives a selection of the first or next participant on the “Unwanted Meetings Report” for rescheduling action from the user 12(1).

In step 373, the video conferencing system 14 displays all matches for that participant who do not already have a meeting scheduled with them and who are available for the time slot. This includes matches with unresolved participants that are in the “Unwanted Meetings Report” except for the match that is identified as unwanted.

In step 374, the video conferencing system 14 receives a selection of a match from the options presented or confirms no match or skip from the user device 12(1).

In step 375, the video conferencing system 14 updates participant schedules for the resolved timeslot, updates participant(s) as resolved in the “Unwanted Meeting Report”, and generates a schedule update email message to the affected participants.

In step 376, the video conferencing system 14 determines if there are unresolved participants remain. If the video conferencing system 14 determines that there are unresolved participants, then the Yes branch is taken to step 372 as illustrated above. However, if the video conferencing system 14 determines that there are no unresolved participants, then the No branch is taken to step 377.

In step 377, the video conferencing system 14 receives a confirmation of the final schedule from the user device 12(1).

In step 378, the video conferencing system 14 pushes final approved schedules to video meeting platform. In this example, an individual participant links are created sent in an email as an update to calendar events participants already have.

In step 379, the video conferencing system 14 begins to monitor live meeting management system about 2 hours before the event session begins.

In step 380, the video conferencing system 14 displays and continuously updates these event status reports live as changes occur: Participants not logged in, participant cancellations, participants reporting technical difficulty, and participant notifications of temporary unavailability.

In step 381, the video conferencing system 14 communicates with participants not logged in to determine their availability for event session.

In step 382, the video conferencing system 14 updates participant status in the Live Meeting Management System as needed.

In step 383, the video conferencing system 14 takes action as necessary to alleviate technical difficulties.

In step 384, the video conferencing system 14 receives a selection of a canceled participant for action in the Live Meeting Management System.

In step 385, the video conferencing system 14 displays canceler's schedule starting with the next available meeting time. A countdown clock to that meeting time is also displayed. The participant that canceler was to meet with in that time slot is displayed along with all matches for that participant who do not already have a meeting scheduled with them and who are available for this time slot.

In step 386, the video conferencing system 14 receives a selection of a match from the options presented or confirms no match or skip.

In step 387, the video conferencing system 14 updates schedule for remaining participant in resolved timeslot and generates a schedule update message that will appear on their next private break screen (e.g., “Participant X is unable to be with us, so you will have a break during that time slot.” Or “Participant X is unable to be with us, you are now scheduled with Y at that time.”

In step 388, the video conferencing system 14 determines if there are unresolved meeting slots remaining for the canceler. If the video conferencing system 14 determines that there are unresolved meeting slots remaining for this canceler, then the Yes branch is taken to step 385 as illustrated above. However, if the video conferencing system 14 determines that there are no unresolved meeting slots remaining for this canceler, then the No branch is taken to step 389.

In step 389, the video conferencing system 14 determines if there are unresolved cancelled schedules remaining. If the video conferencing system 14 determines that there are unresolved cancelled schedules remaining, then the Yes branch is taken to step 384 as illustrated above. However, if the video conferencing system 14 determines that there are no unresolved cancelled schedules remaining, then the No branch is taken to step 390.

In step 390, the video conferencing system 14 receives a log in from all participants for their first scheduled meeting (or their next scheduled meeting if they have a break or are forced to step away temporarily) using link provided as part of their calendar event invitation.

In step 391, the video conferencing system 14 displays the participants private lobby/break screen with video and sound check function, countdown clock to first meeting, upcoming meetings, next meeting details (e.g., subject, organization, and person).

In step 392, the video conferencing system 14 assists with the participants testing their video and sound for the event.

In step 393, during the event hosted by the video conferencing system 14 if a participant discovers they must be away temporarily, they may select an away message and estimate the amount of time they will be away.

In step 394, the video conferencing system 14 displays away message to person the away participant was to meet, including a countdown clock for their return if they provided an expected time to return. Away status for this participant also appears for host user on Live Meeting Management System.

In step 395, the video conferencing system 14 displays the private lobby/break screen for the away participant with the message WHEN YOU'RE AVAILABLE TO REJOIN YOUR MEETING SCHEDULE IN PROGRESS PLEASE SELECT: “Join meeting already underway.” or “Join at the beginning of my next meeting.”

In step 396, during the meeting hosted by the video conferencing system 14, when temporarily away participants return, they select either “Join meeting already underway.” or “Join at the beginning of my next meeting.”

In step 397, the video conferencing system 14 automatically starts meeting at the time set by the host user.

In step 398, the video conferencing system 14 hosts the participants meeting for the allotted time.

In step 399, the video conferencing system 14 provides a meeting countdown clock is visible to all participants. At 30 seconds to go, a tone sounds and the countdown becomes highlighted. A 10 seconds to go, the countdown clock flashes on each second.

In step 400, the video conferencing system 14 automatically ends all meetings at the time set by the host user and participants are returned to their private lobby/break screens. Additionally, the video conferencing system 14 provides access of the summary after the meeting is completed to the participant. Alternatively, the video conferencing system 14 can send an email to each vendor after each meeting they have with whatever notes they had made and whatever other information we had provided about the provider they just met with. When provider feedback is been received, that could be another email to the vendor.

In step 401, the video conferencing system 14 determines if there is a group A participant or a Group B participant. If the video conferencing system 14 determines that there are Group A participants, then the flow proceeds to step 402.

In step 402, the video conferencing system 14 displays Group A lobby/break screen 1 including: rate last meeting, an image and brief description of what was discussed in meeting just ended. It also displays countdown to next meeting.

In step 403, the video conferencing system 14 receives a feedback regarding the last meeting including “Save for review” or “Not interested at this time”.

In step 404, the video conferencing system 14 displays Group A lobby/break screen 2. It includes an image and brief description of what will be discussed in the next meeting and displays a countdown to next meeting.

However, back in step 401, if the video conferencing system 14 determines that it is Group B participants, then the flow proceeds to step 405.

In step 405, the video conferencing system 14 displays Group B lobby/break screen. It is a split screen. Left side contains name(s), organization, contact info for person(s) in the meeting just ended, and a large field for notes. Right side contains next meeting info including image, contact info, other relevant information and a countdown to the next meeting.

In step 406, the video conferencing system 14 receives a notes from the Group B participant regarding the meeting(s) completed.

In step 407, the video conferencing system 14 determines if there are pending scheduled meetings in this session. If the video conferencing system 14 determines that there are pending meetings to be scheduled, then the Yes branch is taken back to step 397 illustrated above. However, if the video conferencing system 14 determines that there are no more meetings scheduled in the session, then the No branch is taken to step 408.

In step 408, the video conferencing system 14 determines if the participant is a Group A participant or a Group B participant. If the video conferencing system 14 determines that it is a Group A participant, then the flow proceeds to step 409.

In step 409, the video conferencing system 14 presents Group A post-session action screen 1. It includes a list view of all meetings from the just completed session that the Group A participant rated as “Save for Review” and a navigation button “Browse meetings not saved for review.”

In step 410, the video conferencing system 14 receives a selection from the Group A participant to review a meeting.

In step 411, the video conferencing system 14 presents Group A post-event action screen 2. It includes an image and brief description of what was discussed in the selected meeting, a “Note to Group B Participant” field, and a list of actions to request of the Group B participant with check boxes—e.g., “No action at this time”, “Contact me by email”, “Contact me by phone”, “Text me”, “Send sample”, “Arrange Follow-up meeting.”

In step 412, the video conferencing system 14 receives notes regarding the meeting from the Group A participant.

In step 413, the video conferencing system 14 determines if there are more meetings to review. If the video conferencing system 14 determines that there are more meetings to review, then the Yes branch is taken to step 410. However, if the video conferencing system 14 determines that there are no more meetings to review, then the No branch is taken to step 414.

In step 414, the video conferencing system 14 assists the Group A participant to download the meeting summary for the session.

However, back in step 408, if the video conferencing system 14 determines that it is a Group B participant, then the flow proceeds to step 415.

In step 415, the video conferencing system 14 presents Group B post-session action screen 1. It includes a list view of all of the participant's meetings in this session.

In step 416, the video conferencing system 14 receives a selection of a meeting to review from the Group B participant.

In step 417, optionally, the video conferencing system 14 presents Group B post-event action screen 2. It includes contact info for person(s) in the meeting selected, and a large field for notes, image, other relevant information.

In step 418, the video conferencing system 14 receives complete notes from the Group B participant.

In step 419, the video conferencing system 14 determines if there are more meetings to review. If the video conferencing system 14 determines that there are more meetings to review, then the Yes branch is taken to 416. However, if the video conferencing system 14 determines that there are no more meetings to review, then the No branch is taken to step 420.

In step 420, the video conferencing system 14 assists the Group B participant to download the summary of the session.

In step 421, the video conferencing system 14 assists the participants to log off from the session and the exemplary method ends.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A method for providing a seamless video conferencing system comprising:
receiving, by a video conferencing system, participant data for a video conferencing session, wherein the participant data comprises a plurality of participants and demographic data associated with the plurality of participants;
identifying, by the video conferencing system, a match between the plurality of participants for the video conferencing session based on participant criteria and the demographic data;
scheduling, by the video conferencing system, one or more meetings sequentially between the matched participants without receiving input from the matched participants;
revising, by the video conferencing system, the scheduled one or more meetings based on input from the matched participants; and
hosting and providing, by the video conferencing system, the revised one or more meetings sequentially without receiving from the plurality of participants, session login data associated with the video conferencing session.

2. The method as set forth in claim 1 wherein the plurality of participants automatically transitions from one meeting to another meeting in the scheduled one or more meetings without providing the session login data associated with the video conferencing session.

3. The method as set forth in claim 1 further comprising, providing, by the video conferencing system, a link to the plurality of participants to join an event.

4. The method as set forth in claim 3 wherein the plurality of participants can participate in all of the scheduled one or more meetings by clicking only once on the provided link.

5. The method as set forth in claim 1 wherein the each of the scheduled one or more meetings has a predetermined time and wherein plurality of participants transition from one meeting to another meeting within the scheduled one or more meetings after expiration of the predetermined time.

6. The method as set forth in claim 1 wherein the scheduled one or more meetings occur between the match plurality of participants concurrently.

7. A non-transitory machine readable medium having stored thereon instructions comprising machine executable code which when executed by at least one machine causes the machine to:
receive participant data for a video conferencing session, wherein the participant data comprises a plurality of participants and demographic data associated with the plurality of participants;
identify a match between the plurality of participants for the video conferencing session based on participant criteria and the demographic data;
schedule one or more meetings sequentially between the matched participants without receiving input from the matched participants;
revise the scheduled one or more meetings based on input from the matched participants; and
host and provide the revised one or more meetings sequentially without receiving from the plurality of participants, session login data associated with the video conferencing session.

8. The medium as set forth in claim 7 wherein the plurality of participants automatically transitions from one meeting to another meeting in the scheduled one or more meetings without providing the session login data associated with the video conferencing session.

9. The medium as set forth in claim 7 further comprising, providing a link to the plurality of participants to join an event.

10. The medium as set forth in claim 9 wherein the plurality of participants can participate in all of the scheduled one or more meetings by clicking only once on the provided link.

11. The medium as set forth in claim 7 wherein the each of the scheduled one or more meetings has a predetermined time and wherein plurality of participants transition from one meeting to another meeting within the scheduled one or more meetings after expiration of the predetermined time.

12. The medium as set forth in claim 7 wherein the scheduled one or more meetings occur between the match plurality of participants concurrently.

13. A video conferencing system, comprising a memory comprising programmed instructions stored in the memory and one or more processors configured to be capable of executing the programmed instructions stored in the memory to:
receive participant data for a video conferencing session, wherein the participant data comprises a plurality of participants and demographic data associated with the plurality of participants;
identify a match between the plurality of participants for the video conferencing session based on participant criteria and the demographic data;
schedule one or more meetings sequentially between the matched participants without receiving input from the matched participants;
revise the scheduled one or more meetings based on input from the matched participants; and
host and provide the revised one or more meetings sequentially without receiving from the plurality of participants, session login data associated with the video conferencing session.

14. The system as set forth in claim 13 wherein the plurality of participants automatically transitions from one meeting to another meeting in the scheduled one or more meetings without providing the session login data associated with the video conferencing session.

15. The system as set forth in claim 13 wherein the one or more processors are further configured to be capable of executing the programmed instructions stored in the memory to provide a link to the plurality of participants to join an event.

16. The system as set forth in claim 15 wherein the plurality of participants can participate in all of the scheduled one or more meetings by clicking only once on the provided link.

17. The system as set forth in claim 13 wherein the each of the scheduled one or more meetings has a predetermined time and wherein plurality of participants transition from one meeting to another meeting within the scheduled one or more meetings after expiration of the predetermined time.

18. The system as set forth in claim 13 wherein the scheduled one or more meetings occur between the match plurality of participants concurrently.
